(19) United States
(12) Patent Application Publication
(10) Pub. No.: US 2024/0251871 A1
(43) Pub. Date: Aug. 1, 2024

(54) AEROSOL GENERATING DEVICE FOR PROVIDING PUFF COMPENSATION AND METHOD THEREOF

(71) Applicant: KT&G CORPORATION, Daejeon (KR)

(72) Inventors: Yong Hwan KIM, Gyeonggi-do (KR); Dong Sung KIM, Seoul (KR); Seung Won LEE, Gyeonggi-do (KR); Seok Su JANG, Daejeon (KR); Dae Nam HAN, Seoul (KR)

(73) Assignee: KT&G CORPORATION, Daejeon (KR)

(21) Appl. No.: 18/565,388

(22) PCT Filed: Jun. 8, 2022
(86) PCT No.: PCT/KR2022/008088

§ 371 Date: Nov. 29, 2023

(30) Foreign Application Priority Data
Jun. 29, 2021 (KR) 10-2021-0085038

(51) Int. Cl. A24F 40/53; A24F 40/20; A24F 40/51; A24F 40/60

(52) U.S. Cl. CPC A24F 40/53; A24F 40/51; A24F 40/60; A24F 40/20

(57) ABSTRACT

According to an embodiment of the present disclosure, provided is an aerosol generating device including a cigarette including an aerosol generating substance, a puff detecting sensor configured to detect a puff, and a controller configured to control power supplied to a heater configured to heat the cigarette, wherein the controller is further configured to, based on the puff detected by the puff detecting sensor, calculate an accumulated inhaling amount up to a first time point, and based on the accumulated inhaling amount calculated at a first time point, determine whether to extend a preset smoking time.

### TECHNICAL FIELD

Embodiments of the present disclosure relate to an aerosol generating device and a method thereof, and more particularly, to an aerosol generating device configured to detect whether a user has not been provided with a sufficient smoking experience and to compensate for an additional smoking experience, and a method of the device.

### BACKGROUND ART

Recently, there has been a growing demand for alternative methods of resolving problems of common cigarettes. For example, there is an increasing demand for a method of generating aerosols by heating an aerosol generating material in a cigarette rather than a method of generating aerosols by burning a cigarette. Accordingly, research into a heating-type cigarette or a heating-type aerosol generating device has been actively conducted.

### DISCLOSURE OF INVENTION

### Technical Problem

A heating-type aerosol generating device according to an embodiment may be designed to provide a user with a sufficient preset amount of aerosols, but when a sufficient smoking time is not ensured for the user due to the user's personal circumstances, the user may not fully inhale the aerosols provided by the aerosol generating device, resulting in an unsatisfactory smoking experience.

### Solution to Problem

One or more embodiments include an aerosol generating device configured to, by monitoring a puff state of a user, detect that the user has not sufficiently inhaled aerosols via the aerosol generating device, and to provide puff compensation to the user, and a method of implementing puff compensation.

According to embodiments, a device includes: a cigarette including an aerosol generating substance; a puff detecting sensor configured to detect a puff; and a controller configured to control power supplied to a heater configured to heat the cigarette, wherein the controller is further configured to, based on the puff detected by the puff detecting sensor, calculate an accumulated inhalation amount up to a first time point, and based on the calculated accumulated inhalation amount, determine whether to extend a preset smoking time.

According to one or more embodiments, the controller may determine an additional time to be added to the smoking time, based on a difference between the accumulated inhalation amount up to the first time point and a preset standard inhalation amount.

According to one or more embodiments, the controller may determine an additional puff number to be added to the smoking time, based on a difference between the accumulated inhalation amount up to the first time point and a preset standard inhalation amount.

According to one or more embodiments, the controller may control to output a guidance message about whether to extend smoking time via an output unit at a second time point, and determine whether to extend the smoking time according to a user input.

According to one or more embodiments, the first time point may be a point of time 2 minutes to 3 minutes and 30 seconds after a time point at which an initial puff is started, and the second time point may be a time point when 20 seconds to 40 seconds are left until the smoking time is terminated.

According to one or more embodiments, the first time point may be a point of time 2 minutes to 3 minutes and 30 seconds after a time point at which an initial puff is started, and the second time point may be a time point when the controller determines an 11^{th} puff from a result detected by the puff detecting sensor.

According to one or more embodiments, the smoking time may be 3 minutes to 6 minutes from a time point when an initial puff starts.

According to one or more embodiments, the puff detecting sensor may be a pressure sensor.

According to one or more embodiments, the puff detecting sensor may be a temperature sensor.

According to embodiments, a method includes: based on a puff detected by a puff detecting sensor, calculating an accumulated inhalation amount up to a first time point; determining whether the calculated accumulated inhalation amount satisfies a condition for puff compensation; and when the condition is satisfied, monitoring whether a preset puff number or a second time point is reached and; when the puff number or the second time point is reached, changing a remaining puff number or a remaining time.

According to one or more embodiments, when the condition is satisfied, whether the preset puff number or the second time point is reached may be monitored, and when the puff number of the second time point is reached, the remaining puff number or the remaining time may be changed.

According to one or more embodiments, the changed remaining time may be calculated based on a difference between the accumulated inhalation amount up to the first time point and a preset standard inhalation amount.

According to one or more embodiments, the changed remaining puff number may be calculated based on a difference between the accumulated inhalation amount up to the first time point and a preset standard inhalation amount.

According to one or more embodiments, the changing of the remaining puff number or the remaining time may include controlling to output a guidance message via an output unit at the second time point, and changing the remaining puff number or the remaining time according to a user input.

### Advantageous Effects of Invention

According to embodiments of the present disclosure, when a user has not inhaled aerosols sufficiently, puff compensation can be stably provided to the user.

### BRIEF DESCRIPTION OF DRAWINGS

FIG. 1 is a diagram illustrating an example in which a cigarette is inserted into an aerosol generating device.

FIG. 2 is a diagram illustrating another example in which a cigarette is inserted into an aerosol generating device.

FIG. 3 is a diagram showing another example in which a cigarette is inserted into an aerosol generating device.

FIG. 4 is a diagram showing an example of a cigarette.

FIG. 5 is a diagram showing another example of a cigarette.

FIG. 6 is a diagram showing an example of a double medium cigarette used in the aerosol generating device of FIG. 3.

FIG. 7 is a perspective view of an example of an aerosol generating device according to an embodiment of the present disclosure.

FIG. 8 is a side view of the aerosol generating device of FIG. 7.

FIG. 9 is a graph of a change in temperature and an inhalation amount with respect to time change, for explaining an embodiment of the present disclosure.

FIG. 10 is a diagram schematically showing a controller included in an aerosol generating device.

FIG. 11 is a diagram showing an example of a guidance message output via an output unit.

FIG. 12 is a diagram schematically showing an example of a user applies an input to an output unit.

FIG. 13 is a diagram showing a graph of a puff filter value.

FIG. 14 is a diagram showing an amplitude analysis graph for a puff filter value of FIG. 13.

FIG. 15 is a diagram showing an interval analysis graph for a puff filter value of FIG. 13.

FIG. 16 is a diagram schematically showing a graph of an accumulated inhalation amount determined by a controller.

FIG. 17 is a diagram illustrating a flowchart of an example of a method of providing puff compensation, according to an embodiment of the present disclosure.

FIG. 18 is a diagram illustrating a flowchart of another example of a method of providing puff compensation, according to an embodiment of the present disclosure.

### BEST MODE FOR CARRYING OUT THE INVENTION

According to embodiments, a device includes: a cigarette including an aerosol generating substance; a puff detecting sensor configured to detect a puff; and a controller configured to control power supplied to a heater configured to heat the cigarette, wherein the controller is further configured to, based on the puff detected by the puff detecting sensor, calculate an accumulated inhalation amount up to a first time point, and based on the calculated accumulated inhalation amount, determine whether to extend a preset smoking time.

### MODE FOR THE INVENTION

With respect to the terms used to describe the various embodiments, general terms which are currently and widely used are selected in consideration of functions of structural elements in the various embodiments of the present disclosure. However, meanings of the terms can be according to intention, a judicial precedence, the appearance of new technology, and the like. In addition, in certain cases, there is also a term arbitrarily selected by the applicant, in which case the meaning will be described in detail in the description of one or more embodiments. Therefore, the terms used in one or more embodiments should be defined based on the meanings of the terms and the general contents of one or more embodiments, rather than simply the names of the terms.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, the present disclosure will now be described more fully with reference to the accompanying drawings, in which non-limiting example embodiments of the present disclosure are shown such that one of ordinary skill in the art may easily work the present disclosure. Embodiments of the disclosure may, however, be embodied in many different forms and should not be construed as being limited to the example embodiments set forth herein.

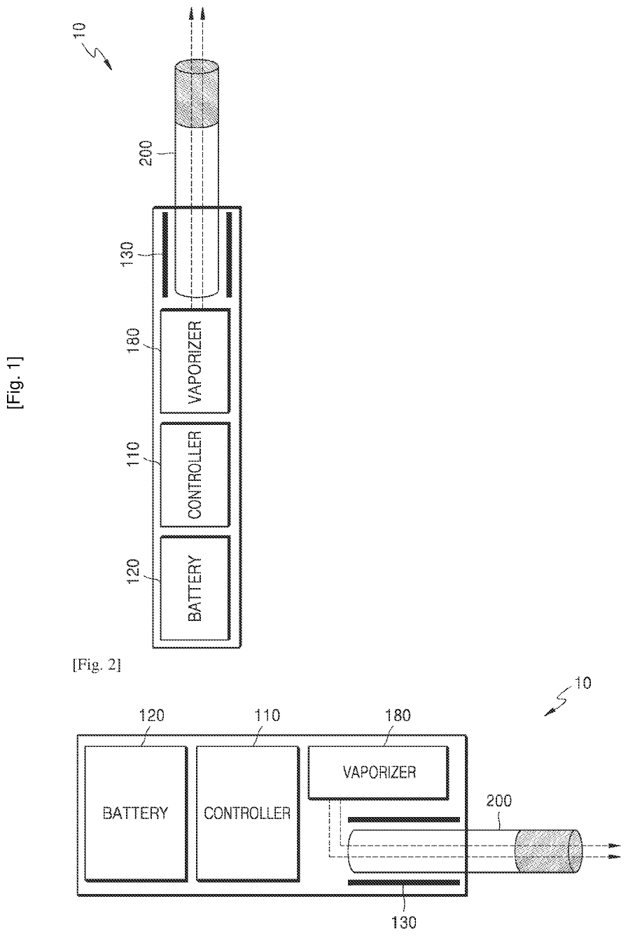

FIGS. 1 and 2 are diagrams showing examples in which a cigarette is inserted into an aerosol generating device.

Referring to FIGS. 1 and 2, an aerosol generating device 10 includes a battery 120, a controller 110, a heater 130, and a vaporizer 180. Also, a cigarette 200 may be inserted into an inner space of the aerosol generating device 10.

FIGS. 1 and 2 illustrate components of the aerosol generating device 10, which are related to the present embodiment. However, it will be understood by one of ordinary skill in the art related to the present embodiment that general-purpose components may be further included in the aerosol generating device 10, in addition to the components illustrated in FIGS. 1 and 2.

Also, although FIGS. 1 and 2 illustrate that the aerosol generating device 10 includes the heater 130, the heater 130 may be omitted according to some embodiments.

FIG. 1 illustrates that the battery 120, the controller 110, the vaporizer 180, and the heater 130 are arranged in series. Also, FIG. 2 illustrates that the vaporizer 180 and the heater 130 are arranged in parallel. However, the internal structure of the aerosol generating device 10 is not limited to the structures illustrated in FIG. 1 or 2. In other words, according to embodiments of the aerosol generating device 10, the battery 120, the controller 110, the vaporizer 180, and the heater 130 may be differently arranged.

When the cigarette 200 is inserted into the aerosol generating device 10, the aerosol generating device 10 may operate the vaporizer 180 to generate an aerosol from the vaporizer 180. The aerosol generated by the vaporizer 180 may be delivered to a user through the cigarette 200. The vaporizer 180 will be described in more detail below.

The battery 120 supplies power to be used for the aerosol generating device 10 to operate. For example, the battery 120 may supply power to heat the heater 130 or the vaporizer 180, and may supply power for operating the controller 110. Also, the battery 120 may supply power for operations of a display, a sensor, a motor, etc. mounted in the aerosol generating device 10.

The controller 110 may generally control operations of the aerosol generating device 10. In detail, the controller 110 may control not only operations of the battery 120, the heater 130, and the vaporizer 180, but also operations of other components included in the aerosol generating device 10. Also, the controller 110 may check a state of each of the components of the aerosol generating device 10 to determine whether or not the aerosol generating device 10 is able to operate.

The controller 110 includes at least one processor. A processor may be implemented as an array of a plurality of logic gates or may be implemented as a combination of a general-purpose microprocessor and a memory in which a program executable in the microprocessor is stored. Also, it will be understood by one of ordinary skill in the art that the processor may be implemented in other forms of hardware.

The heater 130 may be heated by the power supplied from the battery 120. For example, when the cigarette 200 is inserted into the aerosol generating device 10, the heater 130 may be located outside the cigarette 200. Accordingly, the heater 130 that is heated may increase a temperature of an aerosol generating material in the cigarette 200.

The heater 130 may include an electro-resistive heater. For example, the heater 130 may include an electrically conductive track, and the heater 130 may be heated when currents flow through the electrically conductive track. However, the heater 130 is not limited to the example described above and may include all heaters which may be heated to a desired temperature. Here, the desired temperature may be pre-set in the aerosol generating device 10 or may be set as a temperature desired by a user.

As another example, the heater 130 may include an induction heater. In detail, the heater 130 may include an electrically conductive coil for heating a cigarette in an induction heating method, and the cigarette may include a susceptor which may be heated by the induction heater.

FIGS. 1 and 2 illustrate that the heater 130 is located outside the cigarette 200, but is not limited thereto. For example, the heater 130 may include a tube-type heating element, a plate-type heating element, a needle-type heating element, or a rod-type heating element, and may heat the inside or the outside of the cigarette 200, according to the shape of the heating element.

Also, the aerosol generating device 10 may include a plurality of the heater 130. In this case, the plurality of the heater 130 may be inserted into the cigarette 200 or may be arranged outside the cigarette 200. Also, some of the plurality of the heater 130 may be inserted into the cigarette 200, and others may be arranged outside the cigarette 200. Also, the shape of the heater 130 is not limited to the shapes illustrated in FIGS. 1 and 2 and may include various shapes.

The vaporizer 180 may generate an aerosol by heating a liquid composition, and the generated aerosol may pass through the cigarette 200 to be delivered to a user. In other words, the aerosol generated via the vaporizer 180 may move along an air flow passage of the aerosol generating device 10 and the air flow passage may be configured such that the aerosol generated via the vaporizer 180 passes through the cigarette 200 to be delivered to the user.

For example, the vaporizer 180 may include a liquid storage, a liquid delivery element, and a heating element, but it is not limited thereto. For example, the liquid storage, the liquid delivery element, and the heating element may be included in the aerosol generating device 10 as independent modules.

The liquid storage may store a liquid composition. For example, the liquid composition may be a liquid including a tobacco-containing material having a volatile tobacco flavor component, or a liquid including a non-tobacco material. The liquid storage may be formed to be attached/detached to/from the vaporizer 180 or may be formed integrally with the vaporizer 180.

For example, the liquid composition may include water, a solvent, ethanol, plant extract, flavoring materials, flavorings, or a vitamin mixture. The flavoring materials may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be wound around the liquid delivery element. The heating element may be heated by a current supply and may transfer heat to the liquid composition in contact with the heating element, thereby heating the liquid composition. As a result, aerosols may be generated.

For example, the vaporizer 180 may be referred to as a cartomizer or an atomizer, but it is not limited thereto.

The aerosol generating device 10 may further include general-purpose components in addition to the battery 120, the controller 110, and the heater 130. For example, the aerosol generating device 10 may include a display capable of outputting visual information and/or a motor for outputting haptic information. Also, the aerosol generating device 10 may include at least one sensor (e.g., a puff detecting sensor, a temperature detecting sensor, a cigarette insertion detecting sensor, etc.). Also, the aerosol generating device 10 may be formed as a structure where, even when the cigarette 200 is inserted into the aerosol generating device 10, external air may be introduced or internal air may be discharged.

Although not illustrated in FIGS. 1 and 2, the aerosol generating device 10 and an additional cradle may form together a system. For example, the cradle may be used to charge the battery 120 of the aerosol generating device 10. Alternatively, the heater 130 may be heated when the cradle and the aerosol generating device 10 are coupled to each other.

The cigarette 200 may be similar to a general combustive cigarette. For example, the cigarette 200 may be divided into a first portion including an aerosol generating material and a second portion including a filter, etc. Alternatively, the second portion of the cigarette 200 may also include an aerosol generating material. For example, an aerosol generating material made in the form of granules or capsules may be inserted into the second portion.

The entire first portion may be inserted into the aerosol generating device 10, and the second portion may be exposed to the outside. Alternatively, only a portion of the first portion may be inserted into the aerosol generating device 10, and the first portion and a portion of the second portion may be inserted into the aerosol generating device 10. The user may puff aerosol while holding the second portion by the user's mouth. In this case, the aerosol is generated by the external air passing through the first portion, and the generated aerosol passes through the second portion and is delivered to the user's mouth.

For example, the external air may flow into at least one air passage formed in the aerosol generating device 10. For example, the opening and closing and/or a size of the air passage formed in the aerosol generating device 10 may be adjusted by the user. Accordingly, the amount of smoke and a smoking impression may be adjusted by the user. As another example, the external air may flow into the cigarette 200 through at least one hole formed in a surface of the cigarette 200.

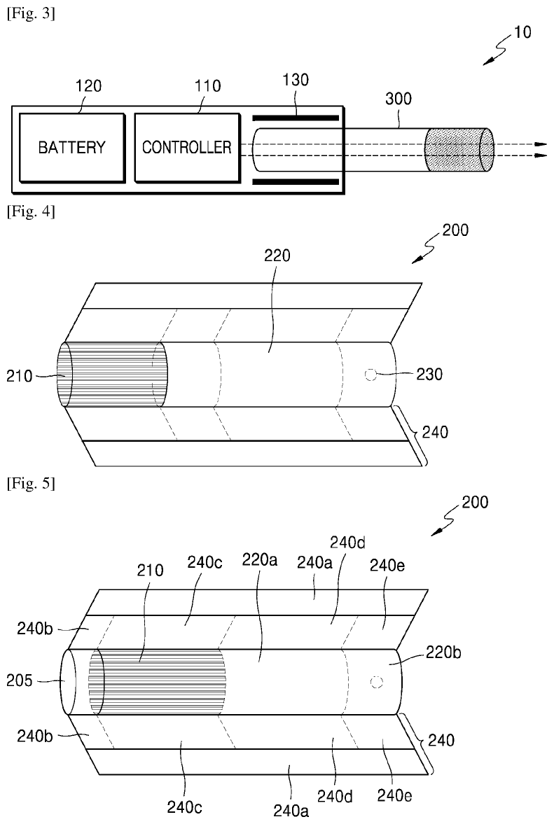

FIG. 3 is a diagram showing another example in which a cigarette is inserted into an aerosol generating device.

Comparing with the aerosol generating device described with reference to FIGS. 1 and 2, the vaporizer 180 is omitted in FIG. 3. Because a double medium cigarette 300 inserted into the aerosol generating device illustrated in FIG. 3 includes an element that performs a function of the vaporizer 180, unlike the aerosol generating device illustrated in FIGS. 1 and 2, the aerosol generating device according to FIG. 3 does not include the vaporizer 180.

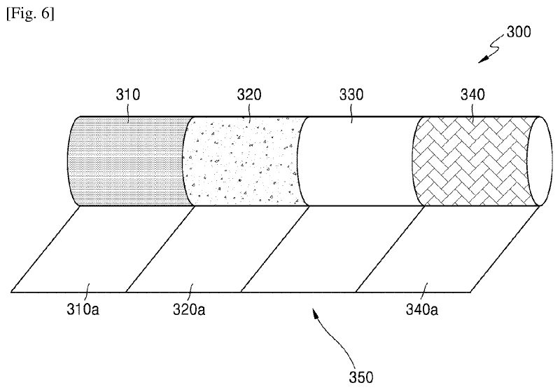

When the double medium cigarette 300 is inserted into the aerosol generating device 10 according to FIG. 3, the aerosol generating device 10 externally heats the double medium cigarette 300 so that aerosols that are inhalable by a user may be generated from the double medium cigarette 300. Also, the double medium cigarette 300 will be described in detail with reference to FIG. 6.

Hereinafter, an example of the cigarette 200 will be described with reference to FIG. 4.

FIG. 4 is a diagram showing an example of a cigarette.

Referring FIG. 4, the cigarette 200 includes a tobacco rod 210 and a filter rod 220. The first portion described above with reference to FIGS. 1 and 2 includes the tobacco rod 210, and the second portion includes the filter rod 220.

In FIG. 4, the filter rod 220 is illustrated as a single segment, but is not limited thereto. In other words, the filter rod 220 may include a plurality of segments. For example, the filter rod 220 may include a first segment configured to cool an aerosol and a second segment configured to filter a certain component included in the aerosol. Also, according to embodiments, the filter rod 220 may further include at least one segment configured to perform other functions.

The cigarette 200 may be packaged via at least one wrapper 240. The wrapper 240 may have at least one hole through which external air is introduced or internal air is discharged. For example, the cigarette 200 may be packaged via one wrapper 240. As another example, the cigarette 200 may be doubly packaged via at least two wrappers 240. For example, the tobacco rod 210 may be packaged via a first wrapper, and the filter rod 220 may be packaged via a second wrapper. Also, the tobacco rod 210 and the filter rod 220, which are respectively packaged via separate wrappers, may be coupled to each other, and the entire cigarette 200 may be re-packaged via a third wrapper. When each of the tobacco rod 210 and the filter rod 220 includes a plurality of segments, each of the segments may be packaged via a separate wrapper. Also, the entire cigarette 200 including the plurality of segments, which are respectively packaged via the separate wrappers and which are coupled to each other, may be re-packaged via another wrapper.

The tobacco rod 210 includes an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 210 may be manufactured in various forms. For example, the tobacco rod 210 may be formed as a sheet or a strand. Also, the tobacco rod 210 may be formed as a pipe tobacco, which is formed of tiny bits cut from a tobacco sheet. Also, the tobacco rod 210 may be surrounded by a heat conductive material. For example, the heat conductive material may be, but is not limited to, a metal foil such as aluminum foil. For example, the heat conductive material surrounding the tobacco rod 210 may uniformly distribute heat transferred to the tobacco rod 210, and thus, the heat conductivity applied to the tobacco rod 210 may be increased, thereby improving taste of a tobacco. Also, the heat conductive material surrounding the tobacco rod 210 may function as a susceptor heated by the induction heater. Here, although not illustrated in the drawings, the tobacco rod 210 may further include an additional susceptor in addition to the heat conductive material surrounding the tobacco rod 210.

The filter rod 220 may include a cellulose acetate filter. The shape of the filter rod 220 is not limited. For example, the filter rod 220 may include a cylinder-type rod or a tube-type rod having a hollow therein. Also, the filter rod 220 may include a recess-type rod. When the filter rod 220 includes a plurality of segments, at least one of the plurality of segments may have a different shape.

The filter rod 220 may be formed to generate flavors. For example, a flavoring liquid may be injected onto the filter rod 220, or an additional fiber coated with a flavoring liquid may be inserted into the filter rod 220.

Also, the filter rod 220 may include at least one capsule 230. Here, the capsule 230 may generate flavors or aerosols. For example, the capsule 230 may have a structure in which liquid including a flavoring material is wrapped with a film. The capsule 230 may have a spherical or cylindrical shape, but is not limited thereto.

When the filter rod 220 includes a segment configured to cool aerosols, the cooling segment may include a polymer material or a biodegradable polymer material. For example, the cooling segment may include pure polylactic acid alone, but is not limited thereto. Alternatively, the cooling segment may include a cellulose acetate filter having a plurality of holes. However, the cooling segment is not limited to the above-described examples and is not limited as long as the cooling segment cools the aerosol.

Although not illustrated in FIG. 4, the cigarette 200 according to an embodiment may further include a front-end filter. The front-end filter may be located on a side of the tobacco rod 210, the side facing the filter rod 220. The front-end filter may prevent the tobacco rod 210 from being detached outwards, and during smoking, prevent a liquefied aerosol from flowing into the aerosol generating device 100 (in FIGS. 1 and 2) from the tobacco rod 210.

FIG. 5 is a diagram showing another example of a cigarette.

Referring to FIG. 5, it may be seen that the cigarette 200 has a shape in which a cross tube 205, the tobacco rod 210, a tube 220a, and a filter 220b are wrapped by plurality of wrappers 240, including a final wrapper 240a. In FIG. 5, the plurality of wrappers 240 includes separate wrappers that respectively surround the cross tube 205, the tobacco rod 210, the tube 220a, and the filter 220b, and the final wrapper 240a that is collectively wrapped around the cross tube 205, the tobacco rod 210, the tube 220a, and the filter 220b, which are respectively surrounded by their own separate wrappers.

The first portion described with reference to FIGS. 1 and 2 includes the cross tube 205 and the tobacco rod 210, and the second portion includes the filter rod 220. For convenience of description, hereinafter, descriptions will be made with reference to FIGS. 1 and 2, and descriptions that overlap with those described with reference to FIG. 4 may be omitted.

The cross tube 205 refers to a cross-shaped tube that is connected to the tobacco rod 210.

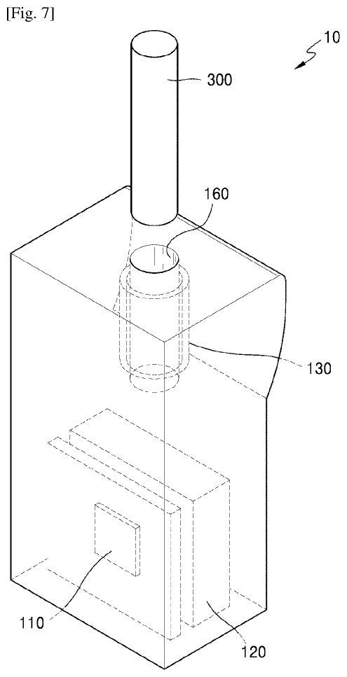

When the cigarette 200 is inserted into an aerosol generating device, the cross tube 205, which is a portion that is sensed, along with the tobacco rod 210, by a cigarette detecting sensor, is wrapped with the same copper laminate wrapper as the tobacco rod 210, and thus, may be utilized to determine whether the cigarette 200 into which the cigarette detecting sensor is inserted is a type of a cigarette supported by the aerosol generating device. The copper laminate wrapper will be described with reference to FIGS. 7 to 9.

The tobacco rod 210 includes an aerosol generating substance that is heated by the heater 130 of the aerosol generating device 10 to generate aerosols.

The tube 220a delivers, to the filter 220b, aerosols that are generated when the aerosol generating substance of the tobacco rod 210 is heated by receiving a sufficient amount of energy from the heater 130. The tube 220a, which is a tube manufactured by adding triacetin (TA), which is a plasticizer, to cellulose acetate tow for a certain amount or more and forming in the form of a circle, differs from the cross tube 205 in terms of the shape and differs from the cross tube 205 in that the tube 220a connects the tobacco rod 210 to the filter 220b.

When aerosols generated from the tobacco rod 210 is transferred to the filter 220b through the tube 220a, the filter 220b passes the aerosols and allows a user to inhale the aerosols filtered by the filter 220b. The filter 220b may be a cellulose acetate filter manufactured based on cellulose acetate tow.

The final wrapper 240a, which is a paper that surrounds each of the cross tube 205, the tobacco rod 210, the tube 220a, and the filter 220b, may include all of a cross tube wrapper 240b, a tobacco rod wrapper 240c, a tube wrapper 240d, and a filter wrapper 240e.

In FIG. 5, the cross tube wrapper 240b is an aluminum wrapper, the tube wrappers 240d is a MFW or 24K wrapper, and the wrappers 240e is an oil resistant hard wrapper or a polylactic acid (PLA) laminated paper. The tobacco rod wrapper 240c and the final wrapper 240a will be described in detail hereinafter.

The tobacco rod wrapper 240c, which is a wrapper that surrounds the tobacco rod 210, may be coated with a thermal conductivity enhancement material to maximize the efficiency of thermal energy transferred by the heater 130. For example, the tobacco rod wrapper 240c may be manufactured in such a manner that at least one of silver foil (Ag), aluminum foil (Al), copper foil (Cu), carbon paper, filler, ceramic (AlN, Al2O3), silicon carbide, sodium citrate (Na citrate), potassium citrate (K citrate), aramid fiber, nano cellulose, mineral paper, glassine paper, single-wall carbon nanotube (SWNT) is coated on a general wrapper or a heterotype base paper. The general wrapper refers to a wrapper that is applied to widely known cigarettes, and refers to a porous wrapper made of a proven material that has both paper manufacturing workability and a thermal conductivity exceeding a certain value via a handsheet test.

Also, in embodiments of the present disclosure, the final wrapper 240a may be manufactured in such a manner that among various materials coated on the tobacco rod wrapper 240c, at least one of filler, ceramic, silicon carbide, sodium citrate, potassium citrate, aramid fiber, nano cellulose, and SWNT is coated on a MFW base paper.

The heater 130 included in the external-heating type aerosol generating device 10 described in FIGS. 1 and 2, which is an object controlled by the controller 110, heats an aerosol generating substance included in the tobacco rod 210 to generate aerosols, and at this time, thermal energy transferred to the tobacco rod 210 consists of 75% of radiant heat, 15% of convection heat, and 10% of conductive heat. According to an embodiment, proportions of radiant heat, convection heat, and conductive heat, which constitute thermal energy transferred to the tobacco rod 210, may vary.

According to embodiments of the present disclosure, due to characteristics of the heater 130 not being able to directly contact an aerosol generating substance to transfer thermal energy, in order to overcome a difficulty in rapid generation of aerosols, as described above, the tobacco rod wrapper 240c and the final wrapper 240a are coated with a thermal conductivity enhancement material to promote the efficient transfer of thermal energy to an aerosol generating substance of the tobacco rod 210, and thus, a sufficient amount of aerosols may be provided to a user even during an initial puff before the heater 130 is sufficiently heated.

According to an embodiment, only one of the tobacco rod wrapper 240c and the final wrapper 240a may be coated with a thermal conductivity enhancement material, and in addition to the above examples, embodiments of the present disclosure may be implemented in such a manner that an organic metal, inorganic metal, fiber, or polymer material having a thermal conductivity of a preset value is coated on the tobacco rod wrapper 240c or the final wrapper 240a.

FIG. 6 is a diagram showing an example of a double medium cigarette used in the device of FIG. 3.

The term “double medium cigarette” in FIG. 6 is not only for differentiating from the cigarette described in FIGS. 4 and 5, but also for simplifying description of embodiments of the present disclosure, and according to an embodiment, may also be referred to as a general cigarette.

Referring to FIG. 6, it may be seen that the double medium cigarette 300 has a shape in which an aerosol substance portion 310, a medium portion 320, a cooling portion 330, and a filter portion 340 are wrapped by a final wrapper 350. In FIG. 6, separate wrappers respectively surround the aerosol substance portion 310, the medium portion 320, and the filter portion 340, and the final wrapper 350 refers to a cover that wraps all together the aerosol substance portion 310, the medium portion 320, and the filter portion 340, which are respectively surrounded by their own separate wrappers.

The aerosol substance portion 310 is a portion formed into a preset shape by including a moisturizer in pulp-based paper. The moisturizer (substance) included in the aerosol substance portion 310 includes propylene glycol and glycerin. The moisturizer of the aerosol substance portion 310 includes propylene glycol and glycerin having a certain weight ratio to a weight of a base paper. In a case where the double medium cigarette 300 is inserted into the aerosol generating device 10 of FIG. 3, when the aerosol substance portion 310 is heated to a temperature above a certain level by the heater 130, the aerosol substance portion 310 generates moisturizer vapor.

The medium portion 320 includes one or more of a sheet, a strand, and a pipe tobacco which is formed of tiny bits cut from a tobacco sheet, and is a portion that generates nicotine in order to provide a smoking experience to a user. Even when the double medium cigarette 300 is inserted into the aerosol generating device 10 of FIG. 3, the medium portion 320 is not directly heated by the heater 130, but may be indirectly heated by conduction, convection, and radiation from a medium portion wrapper (or final wrapper 350) that wraps the heated aerosol substance portion 310 and medium portion 320. In embodiments of the present disclosure, in consideration of a characteristic that a temperature to which a medium included in the medium portion 320 should reach is lower than a temperature to which moisturizers included in the aerosol substance portion 310 should reach, after the aerosol substance portion 310 is heated by the external-heating type heater 130, the temperature of the medium portion 320 is indirectly increased. When the temperature of the medium included in the medium portion 320 is increased to a temperature above a certain level, nicotine vapor is generated from the medium portion 320.

According to an embodiment, when the double medium cigarette 300 is inserted into the aerosol generating device 10 of FIG. 3, a portion of the medium portion 320 may be heated by the heater 130 in a direction facing the heater 130.

The cooling portion 330 is manufactured as a tube filter including a plasticizer of a certain weight, the moisturizer vapor and nicotine vapor generated from the aerosol substance portion 310 and the medium portion 320 are mixed, aerosolized, and cooled while passing through the cooling portion 330, and unlike the aerosol substance portion 310, the medium portion 320, and the filter portion 340, the cooling portion 330 is not wrapped with a separate wrapper.

The filter portion 340 may be a cellulose acetate filter, and the shape of the filter portion 340 is not limited. The filter portion 340 may be a cylindrical type rod, or may be a tube type including a hollow therein. When the filter portion 340 includes a plurality of segments, at least one of the plurality of segments may have a different shape. The filter portion 340 may be manufactured to generate flavors. For example, a flavoring liquid may be injected onto the filter portion 340, or an additional fiber coated with a flavoring liquid may be inserted into the filter portion 340.

Also, the filter portion 340 may include at least one capsule. Here, the capsule may generate flavors. For example, the capsule may have a structure in which liquid including a flavoring material is wrapped with a film, and may have a spherical or cylindrical shape, but is not limited thereto.

The final wrapper 350 refers to a cover that wraps all together the aerosol substance portion 310, the medium portion 320, and the filter portion 340, which are respectively surrounded by their own separate wrappers, and the final wrapper 350 may include the same material as a medium portion wrapper described below.

FIG. 7 is a perspective view of an example of an aerosol generating device according to the present disclosure.

Referring to FIG. 7, it may be seen that the aerosol generating device 10 according to an embodiment of the present disclosure includes the controller 110, the battery 120, the heater 130, and the double medium cigarette 300. For convenience of description, FIG. 7 focuses on and shows only some components of the aerosol generating device 10, and thus, even in a case where other components are added, when the components described above are included, it will be apparent to those of ordinary skill in the art that the present disclosure does not depart from the scope of the present disclosure.

Also, the internal structure of the aerosol generating device 10 is not limited to that shown in FIG. 7, and according to an embodiment, the arrangement of the controller 110, the battery 120, the heater 130, and the double medium cigarette 300 may vary. Each of the components in FIG. 7 has already been described with reference to FIGS. 1 to 3, and thus, descriptions thereof may be omitted.

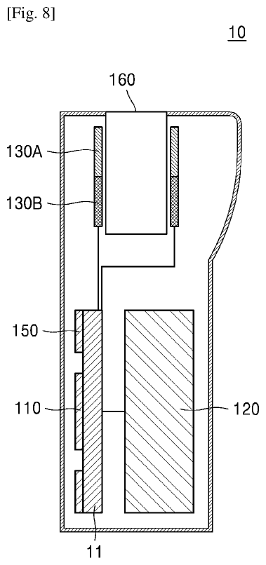

FIG. 8 is a side view of the aerosol generating device of FIG. 7.

Referring to FIG. 8, it may be seen that the aerosol generating device 10 according to an embodiment of the present disclosure includes a printed circuit board (PCB) 11, the controller 110, the battery 120, a first heater 130A, a second heater 130B, a display 150, and a cigarette insertion space 160. Hereinafter, descriptions that overlap with descriptions of the components described with reference to FIG. 1 may be omitted.

The PCB 11 electronically integrates various components that collect information of the aerosol generating device 10 while communicating with the controller 110, and the controller 110 and the display 150 are fixedly mounted on a surface of the PCB 11, which is connected to the battery 120 for supplying power to elements connected to the PCB 11.

The first heater 130A and the second heater 130B heat two medium portions of the double medium cigarette 300 inserted into the cigarette insertion space 160 of the aerosol generating device 10 of FIG. 8 to different temperatures. The first heater 130A and the second heater 130B may include different materials, or while the first heater 130A and the second heater 130B include the same material, the first heater 130A and the second heater 130B may heat the two medium portions of the double medium cigarette 300 to different temperatures by receiving different control signals from the controller 110.

The display 150, which is a device that controls in such a manner that information for a user among information generated by the aerosol generating device 10 is output as visual information, controls information output to an LCD panel (or LED panel) provided on a front surface of the aerosol generating device 10, based on information received from the controller 110.

The cigarette insertion space 160 refers to a space that is concavely dug to a certain depth toward the inside of the aerosol generating device 10 so that the cigarette 200 or the double medium cigarette 300 may be inserted thereinto. The cigarette insertion space 160 has a cylindrical shape so that the stick-shaped cigarette 200 or double medium cigarette 300 may be stably mounted therein, and a height (depth) of the cigarette insertion space 160 may vary according to a length of a region including an aerosol generating material in the cigarette 200 or the double medium cigarette 300.

For example, when the double medium cigarette 300 described with reference to FIG. 6 is inserted into the cigarette insertion space 160, a height of the cigarette insertion space 160 may be equal to the sum of lengths of the aerosol substance portion 310 and the medium portion 320. When the cigarette 200 or the double medium cigarette 300 is inserted into the cigarette insertion space 160, as the first heater 130A and the second heater 130B, which are adjacent to the cigarette insertion space 160, are heated, aerosols may be generated.

FIG. 9 is a graph of a change in temperature and an inhalation amount with respect to time change, for explaining an embodiment of the present disclosure.

Referring to FIG. 9, it may be seen that an overall graph 900 shown in FIG. 9 includes an output unit 910 of an aerosol generating device, a temperature change curve 930 of a heater, a pre-heating point 950, and a pressure change curve 970.

First, the output unit 910 of the aerosol generating device refers to a display device such as an LCD panel (LED panel) located at one side surface of the aerosol generating device, and may visually provide various information to a user by receiving a control signal of a controller (processor) included in the aerosol generating device. Especially, in embodiments the present disclosure, when a time point t₃′ or a time point t₃″ is reached after a certain time has elapsed from a time point at which pre-heating of the heater is completed, the output unit 910 of the aerosol generating device visually outputs, to a user, a notification message about whether to extend a smoking time.

After checking the notification message displayed on the output unit 910, the user may apply a certain input to the aerosol generating device to extend the smoking time. Also, after checking the notification message displayed on the output unit 910, the user may not apply any input to the aerosol generating device to prevent extension of the smoking time. The smoking time and extension of the smoking time will be described below together with descriptions of the pressure change curve 970.

The temperature change curve 930 of the heater in FIG. 9 refers to a graph that visually shows a temperature profile of the heater, which is stored in the controller of the aerosol generating device, over time. In detail, the heater of the aerosol generating device starts receiving power according to a control signal of the controller, reaches a maximum temperature T₅, after reaching temperatures T₁ to T₄ from an initial temperature T₀, and then is controlled so that aerosols may be generated from a cigarette while the temperature thereof is reduced to a certain level. Here, the initial temperature T₀ does not refer to 0 degrees Celsius, but refers to a temperature of the heater at room temperature before the aerosol generating device operates, and T₁ to T₅ may each be 210 degrees Celsius, 215 degrees Celsius, 225 degrees Celsius, 245 degrees Celsius, and 265 degrees Celsius, respectively. It will be understood to those of ordinary skill in the art that the temperature values of the heater may vary according to embodiments according to characteristics of the aerosol generating device, firmware version, medium characteristics of a cigarette used.

According to the temperature change curve 930 of the heater in FIG. 9, the temperature of the heater starts at the initial temperature T₀ and increases to the maximum temperature T₅, and then pre-heating is completed while the temperature thereof decreases to temperature T₄, and thus, the user may use the aerosol generating device. Next, after the temperature of heater decreases to the temperature T₁, the heater is controlled to stably generate aerosols while the temperature is maintained by the controller of the aerosol generating device. The temperature change curve 930 of the heater in FIG. 9 is shown as if the temperature T₁ at which aerosols are stably generated is maintained without change, but substantially, whenever a user's puff is generated, the temperature of the heater is temporarily cooled, and the controller may use a proportional-integral-differential (PID) control technique in order to constantly compensate for the cooled temperature of the heater.

The pre-heating point 950 in FIG. 9 is a point indicating that the heater of the aerosol generating device is heated to a temperature sufficient to heat a cigarette. The temperature of the pre-heating point 950 in FIG. 9 is shown as a point at which temperature T₄ is stably maintained, but according to an embodiment, the temperature of the pre-heating point 950 may be another temperature selected from among temperatures T₁ to T₃.

The pressure change curve 970 in FIG. 9 schematically shows a pressure sensed by a user who uses the aerosol generating device over time. Areas between the pressure change curve 970 and a time axis refers to the total amount of air or aerosols inhaled by a user via the user's inhalation action. For example, area S₁ in FIG. 9 refers to an amount of aerosols substantially provided to a user via the user's first puff at a time point at which pre-heating of the heater is completed.

Also, the unit of pressure on a vertical axis in FIG. 9 may be one of various units for measuring pressure, and is not limited to a specific unit. Especially, the pressure change curve 970 in FIG. 9 is inverted based on an x-axis (time axis) in order to be intuitively expressed in one drawing together with the temperature change curve 930.

Also, when the pressure change curve 970 shown in FIG. 9 is interpreted as a whole, it may be seen that there are nine user's puffs until time point t₂, and amounts of aerosol inhaled by the user via respective puffs are different from each other. The total sum of areas S₁ to S₉ in FIG. 9 may be referred to as an accumulated inhalation amount, and the accumulated inhalation amount may be a main parameter for determining whether puff compensation is made.

An embodiment of the present disclosure will be described with reference to FIG. 9 as follows.

The aerosol generating device according to an embodiment of the present disclosure pre-heats the heater in response to a user's power button input, and the user starts using the aerosol generating device in which the pre-heating is completed from a time point t₁. For example, it is assumed that a smoking mode of the aerosol generating device according to an embodiment of the present disclosure is automatically terminated by the controller based on 14 puffs being made or 4 minutes and 30 seconds of a heating holding time (time length between time point t₁ and time t₄) elapsing.

The user puffs nine times via the aerosol generating device and stops puffing at a time point t₂, and the controller calculates the user's accumulated inhalation amount by analyzing the pressure change curve 970. When it is determined that the accumulated inhalation amount does not reach a preset standard inhalation amount, the controller calculates a puff compensation value. When the puff compensation value is calculated by the controller, the controller controls in such a manner that a notification message about whether to extend a smoking time is output via the output unit 910 of the aerosol generating device at a time point t₃′ or a time point t₃″.

Here, the time point t₃′ may refer to a time point when an eleventh puff is terminated and only three puffs are left until automatic termination of the smoking mode is made, and the time point t₃″ may refer to a time point when 30 seconds are left until automatic termination of the smoking mode is made. Also, the specific values described above may vary according to the configuration of the aerosol generating device, firmware version, temperature profile, etc.

When the user checks the notification message output via the output unit 910 and extends a smoking time, a heating state of the heater is not terminated at time point t₄, which is a time point at which the controller may otherwise may cause an initial automatic termination of the smoking mode, and the smoking time is extended by a puff compensation value. For example, when a puff compensation value is two puffs and a time required for one puff is set to 15 seconds, an extension time is 30 seconds, and the smoking mode of aerosol generating device is automatically terminated by the controller after the two puffs are additionally detected.

For convenience of description, although, in FIG. 9, time point t₂ is shown as a time point at which a ninth puff is performed, time point t₂ merely refers to a time point at which the controller calculates an accumulated inhalation amount in order to determine whether a notification message is output to the output unit 910, and does not refer to a time point at which the last puff is performed. For example, even when three puffs are made in FIG. 9, a time point at which the controller calculates an accumulated inhalation amount is not a time point at which the third puff is terminated, but the time point t₂. For example, the time point t₂ may be a predetermined point of time of 1 minute and 45 seconds before the time point t₄, which is a predetermined time point of automatic termination of operation use (when 4 minutes and 30 seconds have elapsed), and according to an embodiment, the time between the time point t₂ and the time point t₄ may be longer or shorter than 1 minute and 45 seconds.

When an accumulated inhalation amount is greater than a preset standard inhalation amount or is slightly less than the standard inhalation amount, the controller does not calculate a puff compensation value due to determining that a user has had sufficient smoking experience via the aerosol generating device. Here, not calculating of the puff compensation value refers to that the notification message is not output to the output unit 910 at the time point t₃′ or the time point t₃″.

To summarize the above, the aerosol generating device (e.g., the controller of the aerosol generating device) according to an embodiment of the present disclosure may determine whether a user has sufficiently inhaled aerosols via the aerosol generating device at a first time point (time point t₂), and as a result of the determination, when the necessity to provide puff compensation to the user is recognized, outputs a notification message about the puff compensation at a second time point (time point t₃′ or time point t₃″) to thereby provide the puff compensation to a user who wants the puff compensation. In embodiments of the present disclosure, the user who is provided with the puff compensation may be a user who puffs only several times and stops puffing, or may be a user who is not sufficiently provided with aerosols by puffing with a weak inhalation action even when the number of the puffs is sufficient.

In the embodiment described above, the 14 puffs or the 4 minutes and 30 seconds at which the smoking mode of the aerosol generating device is automatically terminated is an example value, and thus, the aerosol generating device according to the present disclosure may be automatically terminated based on the number of puffs being a number less than or greater than 14 or a heating holding time (time length between t₁ and t₄) being a time period shorter than or longer than 4 minutes and 30 seconds.

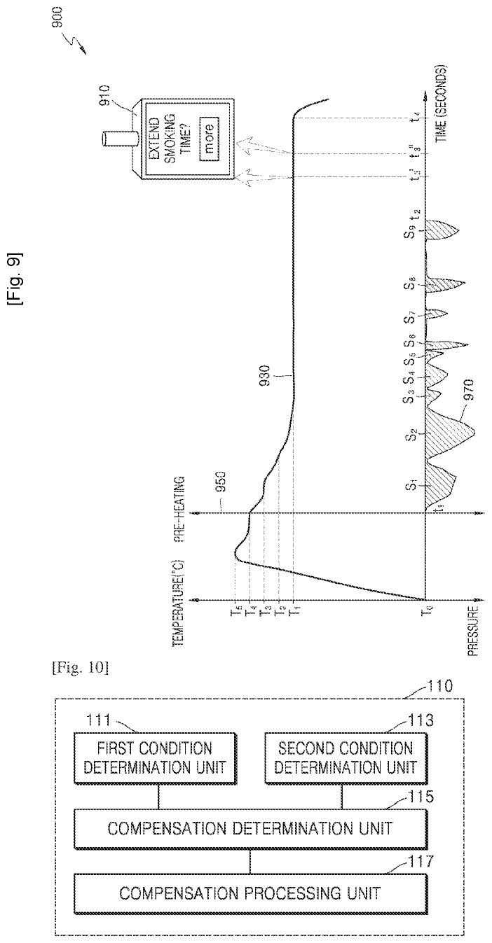

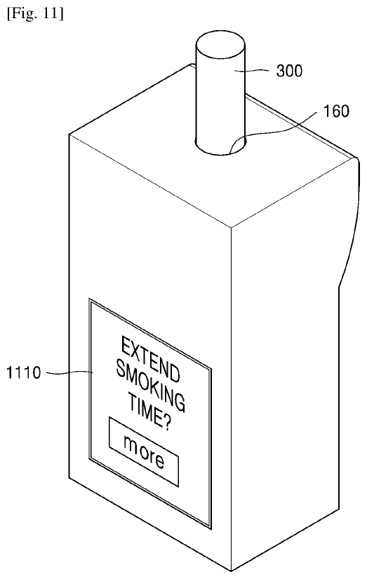

FIG. 10 is a diagram schematically showing a control unit included in an aerosol generating device.

Referring to FIG. 10, it may be seen that the controller 110 according to an embodiment of the present disclosure includes a first condition determination unit 111, a second condition determination unit 113, a compensation determination unit 115, and a compensation processing unit 117. Each module included in the controller 110 is indicated according to the functions thereof for convenience of description, and thus, according to each embodiment, may be indicated differently from those in FIG. 10. It will be apparent to those of ordinary skill in the art that in a case where a module performs the same function as a corresponding module, even when the names thereof are different, the module and the corresponding module are the same. Hereinafter, descriptions will be made with reference to FIG. 9.

The controller 110 calculates an accumulated inhalation amount up to the first time point based on a puff detected by a puff detecting sensor included in the aerosol generating device, and at the second time point, based on the calculated accumulated inhalation amount, determines whether to extend a preset smoking time. It has been already described with reference to FIG. 9 that whether to extend the preset smoking time may be determined according to a user input.

The first condition determination unit 111 monitors the number of puffs of the aerosol generating device, determines whether a certain number of puffs less than the number of puffs for automatic termination of operation use is reached, and causes a notification message about whether to extend a smoking time to be output to the output unit 910. For example, the first condition determination unit 111 determines that the time point t₂ which is a point of time 1 minute and 45 seconds before time point t₄ in FIG. 9 is reached, and based on an accumulated inhalation amount until then being determined to be not sufficient (e.g., less than a predetermined amount), causes the notification message to be output to the output unit 910 at the time point t₃′ at which the number of puffs reaches 11. At this time, the first condition determination unit 111 may operate as a puff counter up to the time point t₃′, and may receive information about the accumulated inhalation amount from the compensation determination unit 115.

The second condition determination unit 113 monitors an operating time of the aerosol generating device, determines whether a time point, which is a certain time before a time of automatic termination of use, has been reached, and causes a notification message about whether to extend a smoking time to be output to the output unit 910. For example, the second condition determination unit 113 determines that the time point t₂ which is a point of time 1 minute and 45 seconds before t₄ in FIG. 9 is reached, and based on an accumulated inhalation amount until being determined to not be sufficient (e.g., less than a predetermined amount), causes the notification message to be output to the output unit 910 at the time point t₃″ which is a point of time 30 seconds before the time point of termination of the smoking mode. In this case, the second condition determination unit 113 may perform time monitoring for the time point t₃″, and may receive information about the accumulated inhalation amount from the compensation determination unit 115. According to an embodiment, the time point t₃″ at which the notification message is output to the output unit 910 may be a point of time 20 seconds to 40 seconds before the time point of termination of the smoking mode.

According to an embodiment, the second condition determination unit 113 may determine whether a time point at which a certain time has elapsed since an initial puff is started is reached while monitoring an operating time of the aerosol generating device. For example, the second condition determination unit 113 may determine that the time point t₂ which is a point of time 2 minutes and 45 seconds after time point t₁ in FIG. 9 is reached, and based on an accumulated inhalation amount until then being determined to not be sufficient (e.g., less than a predetermined amount), cause the notification message to be output to the output unit 910 at the time point t₃″. According to an embodiment, the time point t₂ determined by the second condition determination unit 113 may be a point of time before or after a point of time 2 minutes and 45 seconds after the time point t₁.

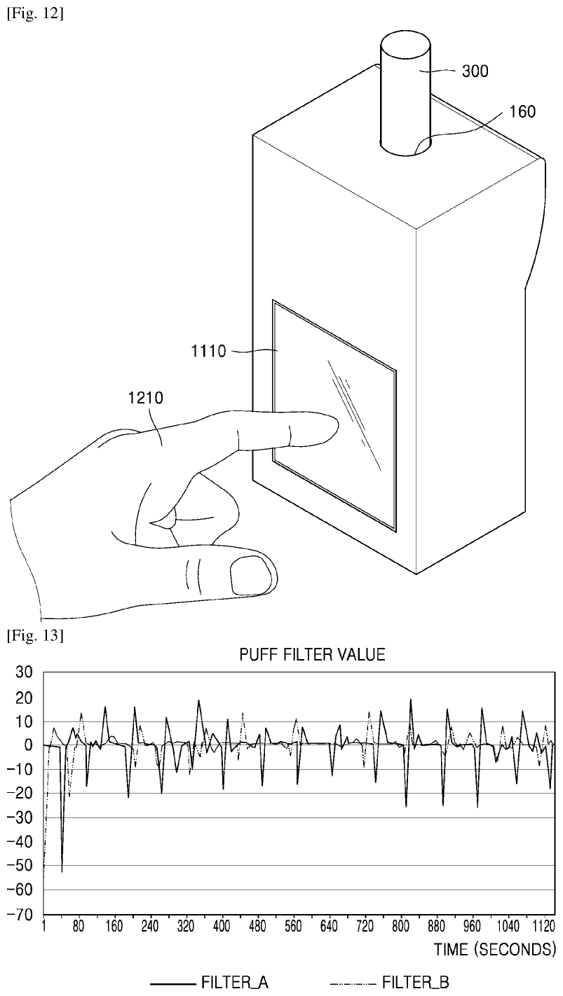

The compensation determination unit 115 calculates a user's accumulated inhalation amount, compares the accumulated inhalation amount with a preset standard inhalation amount, and determines whether to extend a smoking time. As described with reference to FIG. 9, even in a case where the number of puffs reaches 11, or 30 seconds are left until the termination of the smoking mode, when sufficient aerosol has been provided to a user, there is no need to extend a smoking time, and thus, a guidance message about whether to extend a smoking time is not output to the output unit 910. The extension of the smoking time determined by the compensation determination unit 115 will be described in detail with reference to FIGS. 13 to 16.

The compensation processing unit 117 refers to a module configured to add an additional smoking time or an additional puff number to a condition for terminating an existing smoking time when the extension of a smoking time (puff compensation) is determined by the compensation determination unit 115. When the extension of the smoking time is determined by the compensation determination unit 115, the compensation processing unit 117 may further include an algorithm for calculating an additional time or an additional puff number, based on a difference between a calculated accumulated inhalation amount and a preset standard inhalation amount. For example, when an accumulated inhalation amount is 1,000, a preset standard inhalation amount is 1,600, a normal inhalation amount per puff is 200, and a normal time required for one puff is 15 seconds, the compensation processing unit 117 may add three puffs and further extend a time of termination of use by 45 seconds via an embedded algorithm.

FIG. 11 is a diagram showing an example of a guidance massage output via an output unit.

Referring to FIG. 11, a guidance message inquiring whether to extend a smoking time is output to an output unit 1110 of an aerosol generating device of FIG. 11, and a user may check the guidance message and apply an appropriate input to extend the smoking time.

FIG. 12 is a diagram schematically showing that a user applies an input to an output unit.

As shown in FIG. 12, the user may check a guidance message via the output unit 1110 and applies an input within a certain time to extend a smoking time. For example, the user may apply an input 1210 to a portion indicated by “more” in FIG. 11 so that a smoking time is extended.

When the user does not apply an input for extending a smoking time within a certain time, only an initially set smoking time and a maximum number of puffs are provided to the user, and the smoking mode of the aerosol generating device is stopped.

FIG. 13 is a diagram showing a graph of a puff filter value.

More specifically, FIG. 13 shows a result of filtering a value detected by a puff detecting sensor included in an aerosol generating device, and in the graph of FIG. 13, an x-axis refers to time, and a y-axis refers to a filtering result value. FIG. 13 is a graph for facilitating explanation of puff filter results, and it is assumed that a time of automatic termination of use of a heater is not separately set. The puff detecting sensor that may be used in the aerosol generating device according to embodiments of the present disclosure includes not only a pressure sensor but also a temperature sensor, and thus, the unit of a puff filter value is not limited to a specific physical quantity unit.

First, a solid line indicates a result value detected by filter A. Referring to FIG. 13, it may be seen that a puff filter value for filter A varies from a minimum of −53 to a maximum of 20, and positive and negative values coexist by reflecting a user's inhalation and exhalation.

A dotted line indicates a result value detected by filter B. Referring to FIG. 13, it may be seen that a puff filter value for filter B varies from a minimum of −55 and a maximum of 15, and similar to the result of filter A, positive and negative values coexist.

The two results shown in FIG. 13 does not indicate that the aerosol generating device includes two puff detecting sensors, but indicates that when different puff patterns are applied by two different users, puff detection results are different as shown in FIG. 13. Referring to FIG. 13, in general, it may be interpreted that a user with respect to filter A has performed puffs with similar intensities more periodically than a user with respect to filter B.

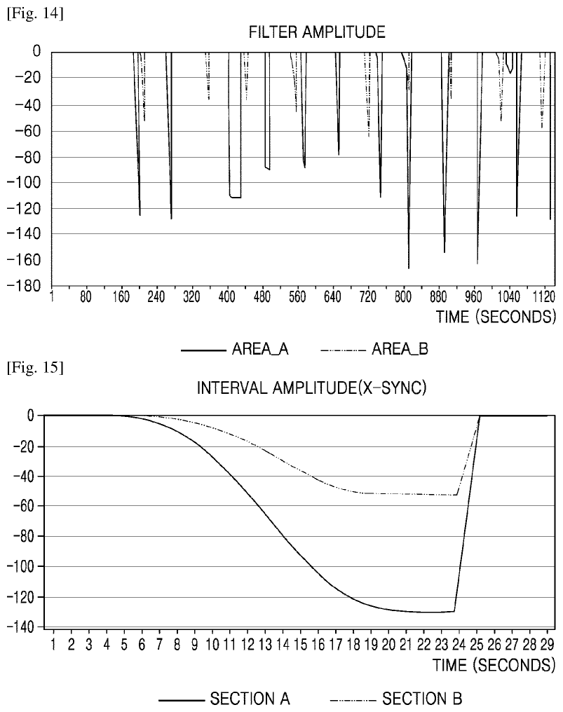

FIG. 14 is a diagram showing an amplitude analysis graph for a puff filter value of FIG. 13.

FIG. 14 shows a result of operation processing an amplitude of the puff filter value described with reference to FIG. 13 according to a preset algorithm, and it may be seen that because an absolute value is employed, unlike FIG. 13, positive and negative values do not coexist, and only one side (negative value) exists.

FIG. 14 is another example of a pressure change curve described with reference to FIG. 9, and referring to FIG. 14, as described with reference to FIG. 9, it may be seen that an area of an inhalation amount per puff and an accumulated inhalation amount may be calculated based on the pressure change curve.

FIG. 14 is an amplitude graph generated based on FIG. 13, and thus, it may be seen that an area corresponding to a user's inhalation amount per puff with respect to filter A is larger than an area corresponding to a user's inhalation amount per puff with respect to filter B. In other words, the graph of FIG. 14 schematically shows that a user's puffing action of filter A has been more efficient than a user's puffing action of filter B.

FIG. 15 is a diagram showing an interval analysis graph for the puff filter value of FIG. 13.

FIG. 15 shows a result of operation processing an interval of the puff filter value described with reference to FIG. 13 according to a preset algorithm of the controller. As an interval between puffs decreases, the regularity of puffs is recognized, and thus, an interval amplitude value of FIG. 15 increases, and on the contrary, when puff is stopped at an early stage, an interval amplitude value of FIG. 15 decreases.

FIG. 16 is a diagram schematically showing a graph of an accumulated inhalation amount determined by a controller.

The accumulated inhalation amount according to FIG. 16 is the sum of inhalation amounts according to a user's puff accumulation, and thus, the sum increases over time, and the accumulated inhalation amount has the same tendency as a result of summing areas per puff described with reference to FIG. 14.

$$AA ( Accumulate Amplitude ) = {\int }_{{t}_{1}}^{{t}_{2}} S ( t ) dt = {\sum }_{k = 1}^{n} {S}_{k} \qquad [ Math . 1 ]$$

Math Figure 1 is an example of an equation for an accumulated inhalation amount calculated by the controller.

In Math Figure 1, AA refers to an accumulated inhalation amount, t₁ refers to a time point at which a user first starts puffing, t₂ refers to a time point at which the controller determines whether to extend a smoking time, S(t) refers to a function of the pressure change curve 970, and Sₖ refers to an inhalation amount for kth puff. That is, Math Figure 1 mathematically indicates that the accumulated inhalation amount may be calculated by integrating an inhalation amount detected for each puff up to the first time point.

According to an embodiment, the accumulated inhalation amount may additionally include an analysis result for an interval amplitude described with reference to FIG. 15.

$$AA = {\int }_{{t}_{1}}^{{t}_{2}} S ( t ) dt + I = {\sum }_{k = 1}^{n} {S}_{k} + I \qquad [ Math . 2 ]$$

Math Figure 2 is another example of an equation for an accumulated inhalation amount calculated by the controller. I in Math FIG. 2 refers to an interval amplitude value described in FIG. 15. The controller may calculate an accumulated inhalation amount as in FIG. 16 by utilizing Math Figure 1 or Math Figure 2, and may determine an additional time or additional number puff number to be added to a condition for terminating a smoking time by comparing the calculated accumulated inhalation amount with a preset standard inhalation amount.

For example, the controller may determine an additional time to be added to a condition for terminating a smoking time at the second time point, based on a difference between an accumulated inhalation amount and a preset inhalation amount. When a user does not puff for a certain time after puffing eight times and has 30 seconds left until a time of termination of the smoking mode, the controller may compensate in such a manner that the user may additionally puff by further adding an additional time to a condition for terminating a preset smoking time. In the present embodiment, the user may check an output guidance message and applies an input in response thereto, to thereby enjoy smoking until all the time obtained by adding the additional time to the 30 seconds that is originally left elapses.

In another embodiment, the controller may determine an additional puff numbers added to a condition for terminating a smoking time at the second time point, based on a difference between an accumulated inhalation amount and a standard inhalation amount. According to the temperature profile set in the controller, it is assumed that the maximum number of puffs of 14 times and the heating holding time of 4 minutes and 30 seconds are guaranteed, and the user rapidly puffs 10 times such that an accumulated inhalation amount calculated at the time point t₂ is 1,400, and a preset standard inhalation amount is 2,000. In the assumption as described above, when an inhalation amount inhaled by one puff is 200, the controller may apply an additional three puffs to a condition for terminating a smoking time and simultaneously add a time for performing the three puffs to the condition for terminating the smoking time.

$$PN = Quotient ( ( {Inhale}_{standard} - AA ) , {Inhale}_{puff} ) \qquad [ Math . 3 ]$$

Math FIG. 3 is an example of an equation used by the controller to calculate an additional puff number. In Math Figure 3, PN refers to an additional puff number, Quotient refers to a function that takes two parameters as factors and returns a quotient obtained by dividing the first parameter by the second parameter, Inhale_{standard} refers to a preset standard inhalation amount, AA refers to an accumulated inhalation amount up to the time point t₂, and Inhale_{puff} refers to a preset inhalation amount per puff. Here, the preset standard inhalation amount is a unique value based on the time point t₂, and when a standard inhalation amount at a time point of termination of the smoking mode (time point t₄) is set in the controller, the controller may additionally calculate a standard inhalation amount at the time point t₂ via a proportional expression and may also calculate PN by using the calculated value.

In an embodiment different from the examples described above, the controller may determine an additional time or additional puff number to be added to a condition for terminating a smoking time at the second time point, based on a difference between an accumulated inhalation amount and a standard inhalation amount, and at the same time, consider a medium limit of a cigarette.

For example, when a user puffs only three times, an accumulated inhalation amount calculated at the time point t₂, which is a puff compensation determination time point, is so small that the controller may determine too much additional time or too many additional puff numbers as a compensation value. Regardless of a user's inhalation action, an aerosol generating substance (medium) included in a cigarette is heated by a heater and constantly consumed, and thus, it is beneficial that a puff compensation value is limited within a certain range. The controller may guide a user to stably inhale aerosols of a certain quality via a cigarette by referring to data about a medium limit at the time point t₂ or presetting an upper limit value of an additional time or additional puff number. In order to implement the present embodiment, the controller may further include data about a medium limit at the time point t₂ and an upper limit value of an additional time or additional puff number.

TABLE 1

| | | | | Medium | |
|---|---|---|---|---|---|
| | Accumulated | Standard | Inhalation | limit or | Additional |
| Case | inhalation | inhalation | amount per | upper | puff |
| no. | amount | amount | puff | limit value | number |
| 1 | 1400 | 2000 | 200 | — | 3 puffs |
| 2 | 1900 | 2000 | 200 | — | 0 puffs |
| 3 | 1200 | 2000 | 200 | — | 4 puffs |
| 4 | 600 | 2000 | 200 | 3 | 3 puffs |

Table 1 is a table in which the embodiments described above are summarized as example values.

Referring to Table 1, the controller may provide puff compensation to a user by calculating an additional time or an additional puff number via Math Figure 1 to Math Figure 3. Also, according to case no. 4 of Table 1, the aerosol generating device according to the present disclosure may provide an appropriate puff compensation in consideration of a medium limit of a cigarette.

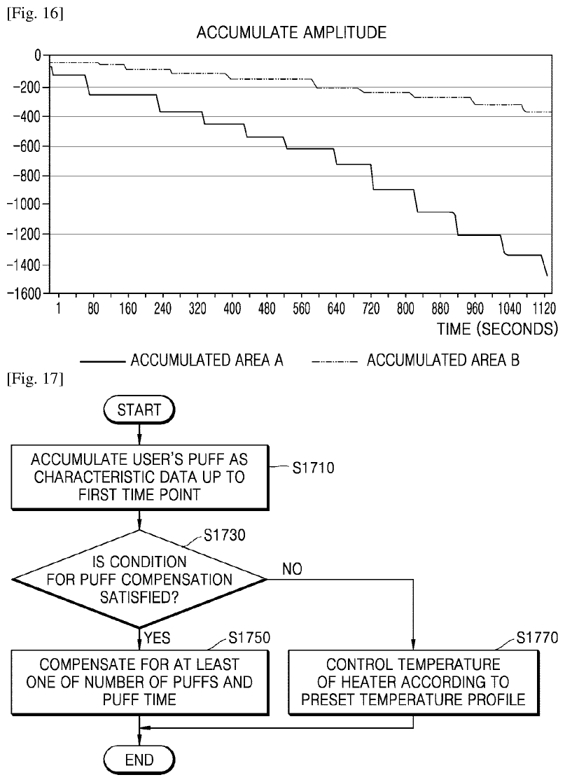

FIG. 17 is a diagram illustrating a flowchart of an example of a method of providing puff compensation, according to the present disclosure.

The method according to FIG. 17 is implemented via the aerosol generating devices described above, and thus, hereinafter, will be described with reference to the drawings described above.

The controller 110 accumulates, as characteristic data, a user's puffs up to the first time point (S1710), and determines whether a condition for puff compensation is satisfied (S1730).

When the condition for puff compensation is satisfied in operation S1730, the controller 110 compensates for at least one of the number of puffs and puff time (S1750).

When the condition for puff compensation is not satisfied in operation S1730, the controller 110 controls the temperature of the heater according to a preset temperature profile (S1770).

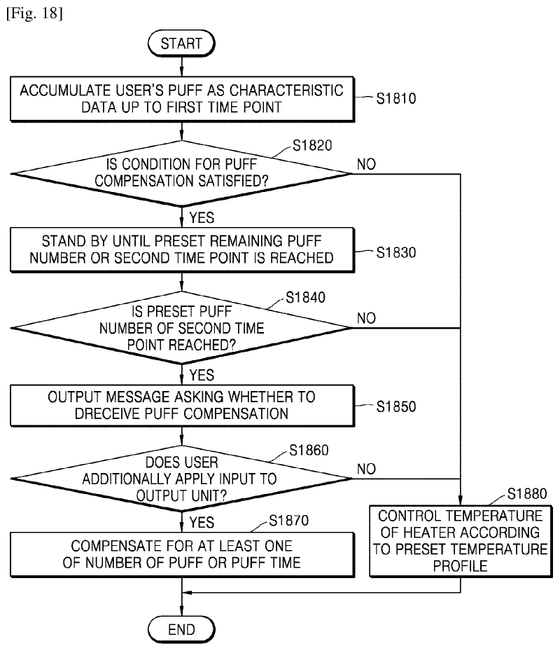

FIG. 18 is a diagram illustrating a flowchart of another example of a method of providing puff compensation, according to an embodiment of the present disclosure.

The method according to FIG. 18 is implemented via the aerosol generating devices described above, and thus, hereinafter, will be described with reference to the drawings described above, and redundant descriptions may be omitted.

The controller 110 accumulates, as characteristic data, a user's puffs up to the first time point (S1810), and determines whether a condition for puff compensation is satisfied (S1820). The user's data accumulated as the characteristic data in operation S1810 refers to an accumulated inhalation amount.

When a condition for puff compensation is satisfied in operation S1820, the controller 110 stands by until a preset remaining puff number or the second time point is reached (S1830).

When the preset puff number or the second time point is reached (S1840), the controller 110 outputs a guidance message asking the user whether to receive the puff compensation via the output unit 910 (S1850).

When the user checks the guidance message of the output unit 910 and additionally applies an input (S1860), the controller 110 compensates for at least one of the number of puffs or puff time (S1870). When the condition for puff compensation is not satisfied, the preset puff number or the second time point is not reached, or the user's additional input is not detected, the controller 110 controls the temperature of the heater according to a preset temperature profile (S1880).

According to embodiments of the present disclosure, comprehensively considering that a user has not been able to stably use an aerosol generating device, the user may be provided with an appropriate puff compensation.

Also, according to embodiments of the present disclosure, even when the user stops puff for a certain period of time, the user may enjoy additional puffs to a maximum without discarding the cigarette, which is economical.

According to embodiments of the present disclosure, “smoking time” may refer to a smoking mode of the aerosol generating device and a condition for termination of the smoking mode. For example, the smoking mode may be a state in which the controller of the aerosol generating device controls other components (e.g. a heater) of the aerosol generating device to enable the cigarette to be smoked. According to embodiments, the condition may include a time or an allowed puff number before the smoking mode is terminated. According to embodiments, the condition may be changed to extend the smoking time.

The above-described embodiments according to the present disclosure may be implemented in the form of a computer program that may be executed via various components on a computer, and the computer program may be recorded in a computer-readable medium. In this regard, the medium may include a hard disk, a magnetic medium such as a floppy disk and a magnetic tape, an optical recording medium such as compact disc-read only memory (CD-ROM) and digital video disc (DVD), a magneto-optical medium such as a floptical disk, and a hardware device specially configured to store and execute program instructions, such as ROM, random access memory (RAM), and flash memory.

The computer program may be specially designed and configured for the embodiments of present disclosure, or may otherwise be understood by those skilled in the computer software field. Examples of the computer program may include not only machine language code generated by a complier, but also high-level language code that is executable by a computer by using an interpreter, etc.

The particular implementations shown and described herein are illustrative examples of the present disclosure and are not intended to otherwise limit the scope of the present disclosure in any way. For the sake of brevity, electronics, control systems, software development and other functional aspects of the systems in the related art may not be described in detail. Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device. Moreover, no item or component is essential to the practice of the present disclosure unless the element is specifically described as “essential” or “critical”.

The use of the terms “a” and “an” and “the” and similar referents in the context of de-scribing the present disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Also, the operations of all methods described herein can be performed in any suitable order unless otherwise indicated herein or otherwise clearly contradicted by context. Embodiments of the present disclosure are not limited to the described order of the operations. The use of any and all examples, or exemplary language (e.g., “such as”) provided herein, is intended merely to better illuminate the present disclosure and does not pose a limitation on the scope of the present disclosure unless otherwise claimed. Numerous modifications and adaptations will be readily apparent to one of ordinary skill in the art without departing from the spirit and scope of the present disclosure.

1. An aerosol generating device comprising:
a cigarette comprising an aerosol generating substance;
a puff detecting sensor configured to detect a puff; and
a controller configured to control power supplied to a heater configured to heat the cigarette,
wherein the controller is further configured to, based on the puff detected by the puff detecting sensor, calculate an accumulated inhalation amount up to a first time point, and based on the calculated accumulated inhalation amount, determine whether to extend a preset smoking time.

2. The aerosol generating device of claim 1, wherein the controller is further configured to, based on a difference between the accumulated inhalation amount up to the first time point and a preset standard inhalation amount, determine an additional time to be added to the smoking time.

3. The aerosol generating device of claim 1, wherein the controller is further configured to, based on a difference between the accumulated inhalation amount up to the first time point and a preset standard inhalation amount, determine an additional puff number to be added to the smoking time.

4. The aerosol generating device of claim 1, wherein the controller is further configured to control to output a guidance message about whether to extend the smoking time via an output unit at a second time point, and determine whether to extend the smoking time according to a user input.

5. The aerosol generating device of claim 4, wherein the first time point is a point of time 2 minutes to 3 minutes and 30 seconds after a time point at which an initial puff is started, and
the second time point is a time point when 20 seconds to 40 seconds are left until the smoking time is terminated.

6. The aerosol generating device of claim 4, wherein the first time point is a point of time 2 minutes to 3 minutes and 30 seconds after a time point at which an initial puff is started, and
the second time point is a time point when the controller determines an 11^{th} puff from a result detected by the puff detecting sensor.

7. The aerosol generating device of claim 1, wherein the smoking time is 3 minutes to 6 minutes from a time point when an initial puff starts.

8. The aerosol generating device of claim 1, wherein the puff detecting sensor comprises a pressure sensor.

9. The aerosol generating device of claim 1, wherein the puff detecting sensor comprises a temperature sensor.

10. The aerosol generating device of claim 1, wherein the controller is further configured to calculate the accumulated inhalation amount by integrating a pressure detected for each puff up to the first time point.

11. A method performed by an aerosol generating device and that provides puff compensation, the method comprising:
based on a puff detected by a puff detecting sensor, calculating an accumulated inhalation amount up to a first time point;
determining whether the calculated accumulated inhalation amount satisfies a condition for puff compensation; and
when the condition is satisfied, changing a remaining puff number or a remaining time.

12. The method of claim 11, wherein the changing of the remaining puff number or the remaining time comprises, when the condition is satisfied, monitoring whether a preset puff number or a second time point is reached, and when the puff number or the second time point is reached, changing the remaining puff number or the remaining time.

13. The method of claim 11, wherein the changed remaining time is calculated based on a difference between the accumulated inhalation amount up to a first time point and a preset standard inhalation amount.

14. The method of claim 11, wherein the changed remaining puff number is calculated based on a difference between the accumulated inhalation amount up to a first time point and a preset standard inhalation amount.

15. The method of claim 11, wherein the changing of the remaining puff number or the remaining time comprises controlling to output a guidance message via an output unit at a second time point, and
changing the remaining puff number or the remaining time according to a user input.
